(19) United States
(12) Patent Application Publication
(10) Pub. No.: US 2003/0048373 A1
(43) Pub. Date: Mar. 13, 2003

(54) Apparatus and method for automatic focusing

(75) Inventors: Noriyuki Okisu, Osakasayama-Ahi (JP); Keiji Tamai, Suita-Shi (JP); Masahiro Kitamura, Osaka-Shi (JP); Motohiro Nakanishi, Kobe-Shi (JP)

Correspondence Address: SIDLEY AUSTIN BROWN & WOOD LLP, 717 NORTH HARWOOD, SUITE 3400, DALLAS, TX, 75201, US

(73) Assignee: Minolta Co., Ltd.

(21) Appl. No.: 10/215,399

(22) Filed: Aug. 8, 2002

(30) Foreign Application Priority Data
Sep. 3, 2001 (JP) 2001-265721

(51) Int. Cl. H04N 5/232

(52) U.S. Cl. 348/350

(57) ABSTRACT

An apparatus for automatic focusing evaluating the significance for realizing in-focus state from the image component of each focus evaluation area, improving the precision of automatic focusing control by performing the calculation by use of a larger number of pixels for an area with a higher significance, and enabling a prompt automatic focusing control, is provided with: area image extractor for extracting an area image from each of a plurality of areas set in the image; area identifier for identifying, from among the plural areas, a high-precision evaluation target area based on an image characteristic of each of the image areas obtained from the plural areas; evaluation value calculator for obtaining, for the high-precision evaluation target area among the plural areas, an evaluation value associated with focus state of the taking lens by use of a larger number of pixels than for the other areas; and controller for driving the taking lens to an in-focus position based on the evaluation value.

This application is based on Japanese Patent Application No. Hei 2001-265721 filed in Japan on Sep. 3, 2001, the entire content of which is hereby incorporated by reference.

### FIELD OF THE INVENTION

The present invention relates to an automatic focusing technology of receiving an image signal that comprises a plurality of pixels and controlling focusing of the taking lens.

### DESCRIPTION OF RELATED ART

A contrast method determining focus state based on the image signal obtained through the taking lens and performing automatic focusing control is known as an automatic focusing technology for digital cameras and the like.

In the automatic focusing control according to the conventional contrast method, a plurality of focus evaluation areas is set for an image in order that in-focus state is realized in a wider range. Then, the taking lens is stepwisely moved in a predetermined direction, an image signal is obtained at each lens position, and an evaluation value (for example, contrast) for evaluating focus state is obtained for each focus evaluation area. Then, for each focus evaluation area, the lens position where the evaluation value is highest is identified as the in-focus position, and from among the in-focus positions obtained for the focus evaluation areas, a single in-focus position (for example, the nearest side position) is identified. The single in-focus position identified here is the lens position where in-focus state is realized by the taking lens. Then, the taking lens is automatically driven to the identified single in-focus position to realize in-focus state.

However, in a case where the automatic focusing control according to the contrast method is performed with high precision, it is desirable to perform calculation by use of a larger number of pixels when the evaluation value for each focus evaluation area is obtained. On the other hand, when the calculation to obtain the evaluation value is performed by use of a large number of pixels for each focus evaluation area, the calculation processing takes a long time, so that it is difficult to perform a prompt automatic focusing control.

### SUMMARY OF THE INVENTION

An object of the present invention is to provide an apparatus and a method for automatic focusing evaluating the significance for realizing in-focus state from the image component of each focus evaluation area, improving the precision of automatic focusing control by performing the calculation by use of a larger number of pixels for an area with a higher significance, and enabling a prompt automatic focusing control.

The above-mentioned object is attained by providing an apparatus and a method for automatic focusing having the following structure:

An automatic focusing apparatus of the present invention is an automatic focusing apparatus receiving an image that comprises a plurality of pixels and controlling focusing of a taking lens, and comprises: area image extractor for extracting an area image from each of a plurality of areas set in the image; area identifier for identifying, from among the plural areas, a high-precision evaluation target area based on an image characteristic of each of the image areas obtained from the plural areas; evaluation value calculator for obtaining, for the high-precision evaluation target area among the plural areas, an evaluation value associated with focus state of the taking lens by use of a larger number of pixels than for the other areas; and controller for driving the taking lens to an in-focus position based on the evaluation value.

Consequently, for the high-precision evaluation target areas, the evaluation value can be obtained with high precision, and for the other areas, the evaluation value can be efficiently obtained, so that a highly precise and prompt automatic focusing control can be performed.

Further, in the automatic focusing apparatus of the present invention, the evaluation value calculator obtains the evaluation value associated with the focus state of the taking lens by more than a predetermined number of pixels for the high-precision evaluation target area, and obtains the evaluation value associated with the focus state of the taking lens by use of less than the predetermined number of pixels for the other areas.

Further, in the automatic focusing apparatus of the present invention, the area identifier obtains, as the image characteristic, a contrast of each of the area images obtained from the plural areas, and when the contrast is higher than a predetermined value, the high-precision evaluation target area is identified from among the plural areas.

Further, in the automatic focusing apparatus of the present invention, the area identifier obtains, as the image characteristic, a distribution of color components of pixels of each of the area images obtained from the plural areas, and when the number of pixels representative of a predetermined color component is larger than a predetermined number, identifies the high-precision evaluation target area from among the plural areas.

Further, in the automatic focusing apparatus of the present invention, the predetermined color component is a skin color component.

Further, in the automatic focusing apparatus of the present invention, the area identifier selects an evaluation target area group from among the plural areas based on the image characteristic, and identifies the high-precision evaluation target area from the evaluation target area group.

Further, in the automatic focusing apparatus of the present invention, the evaluation value calculator obtains the evaluation value associated with the focus state of the taking lens by use of less than the predetermined number of pixels for, of the plural areas, areas included in the evaluation target area group and not included in the high-precision evaluation target area.

Further, in the automatic focusing apparatus of the present invention, the plural areas comprise a plurality of horizontal areas and a plurality of vertical areas, and the area identifier selects either of the plural horizontal areas and the plural vertical areas as the evaluation target area group.

### BRIEF DESCRIPTION OF THE DRAWINGS

These and other objects and features of the present invention will become clear from the following description taken in conjunction with the preferred embodiments thereof with reference to the accompanying drawings, in which:

FIG. 1 is a perspective view showing a digital camera;

FIG. 2 is a view showing the back side of the digital camera;

FIG. 3 is a block diagram showing the internal structure of the digital camera;

FIG. 4 is a view showing an example of focus evaluation areas;

FIG. 5 is a view showing an example of the focus evaluation areas;

FIG. 6 is a view showing an example of the pixel arrangement in horizontal focus evaluation areas;

FIG. 7 is a view showing an example of the pixel arrangement in vertical focus evaluation areas;

FIG. 8 is a view showing a variation of an evaluation value (evaluation value characteristic curve) when the taking lens is driven;

FIG. 9 is a flowchart showing the focusing operation of the digital camera 1;

FIG. 10 is a flowchart showing a first processing mode of an evaluation target area setting processing;

FIG. 11 is a flowchart showing a second processing mode of the evaluation target area setting processing;

FIG. 12 is a flowchart showing a third processing mode of the evaluation target area setting processing; and

FIG. 13 is a flowchart showing a fourth processing mode of the evaluation target area setting processing.

### DETAILED DESCRIPTION OF THE PREFERRED EMBODIMENTS

In the embodiment shown below, description will be given with a digital camera as an example of the image forming apparatus.

<1. Structure of the digital camera>

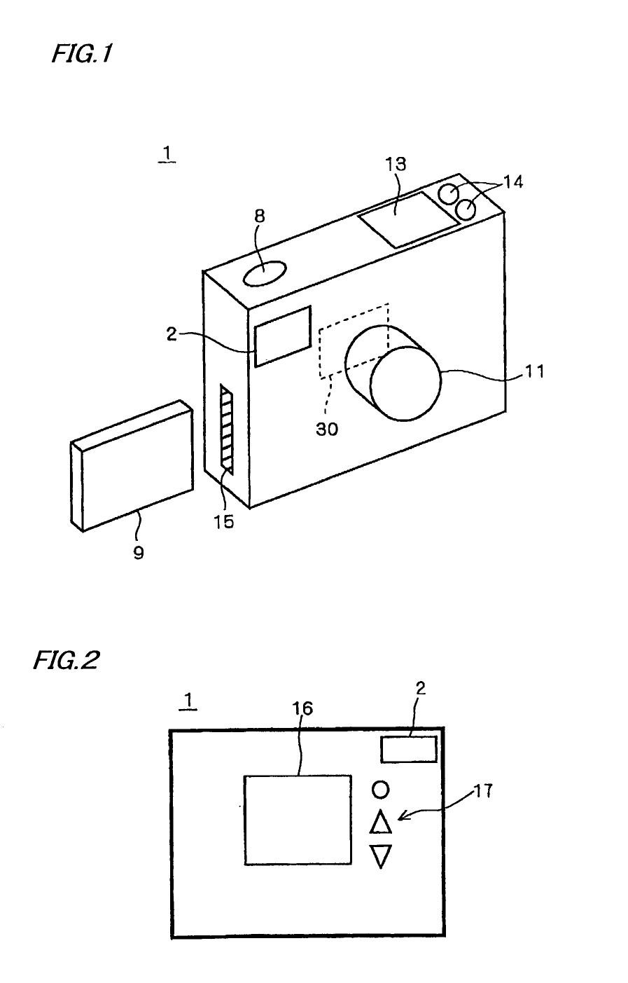

FIG. 1 is a perspective view showing the digital camera 1 according to an embodiment of the present invention. FIG. 2 is a view showing the back side of the digital camera 1.

As shown in FIG. 1, a taking lens 11 and a finder window 2 are provided on the front surface of the digital camera 1. Inside the taking lens 11, a CCD image sensing device 30 is provided as image signal generating means for generating an image signal (signal comprising an array of pixel data of pixels) by photoelectrically converting a subject image incident through the taking lens 11.

The taking lens 11 includes a lens system movable in the direction of the optical axis, and is capable of realizing in-focus state of the subject image formed on the CCD image sensing device 30 by driving the lens system.

A release button 8, a camera condition display 13 and photographing mode setting buttons 14 are disposed on the upper surface of the digital camera 1. The release button 8 is a button which, when photographing a subject, the user depresses to provide a photographing instruction to the digital camera 1. The camera condition display 13 comprising, for example, a liquid crystal display of a segment display type is provided for indicating the contents of the current setting of the digital camera 1 to the user. The photographing mode setting buttons 14 are buttons for manually selecting and setting a photographing mode at the time of photographing by the digital camera 1, that is, a single photographing mode in accordance with the subject from among a plurality of photographing modes such as a portrait mode and a landscape mode.

An insertion portion 15 for inserting a recording medium 9 for recording image data obtained in photographing for recording performed by the user depressing the release button 8 is formed on a side surface of the digital camera 1, and the recording medium 9 which is interchangeable can be inserted therein.

As shown in FIG. 2, a liquid crystal display 16 for displaying a live view image, a photographed image and the like, operation buttons 17 for changing various setting conditions of the digital camera 1 and the finder window 2 are provided on the back surface of the digital camera 1.

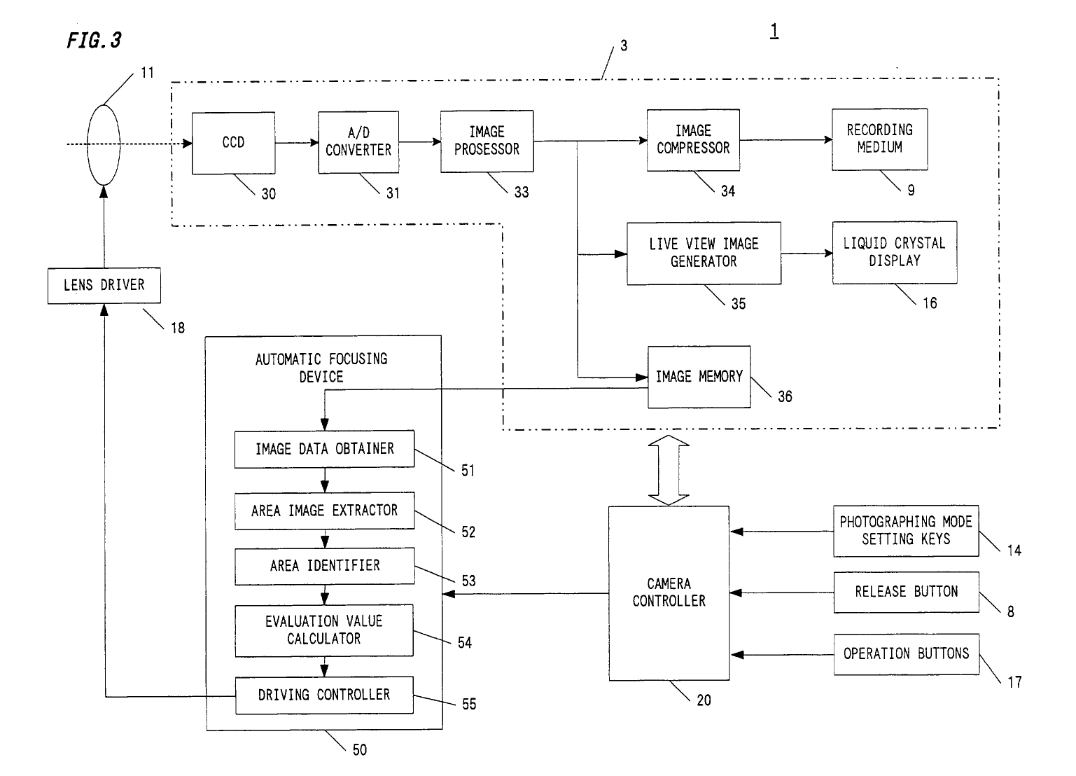

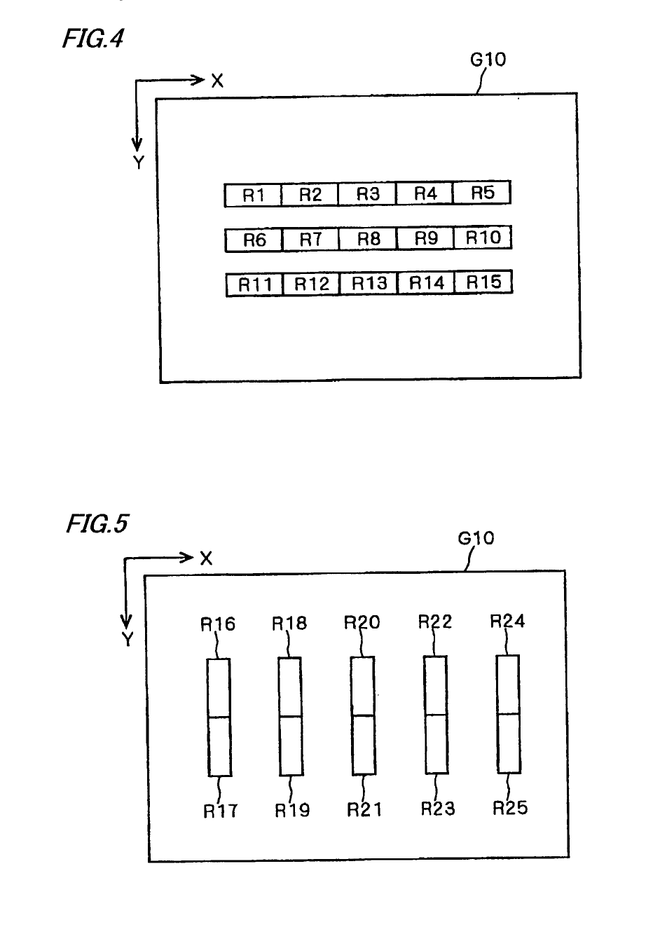

FIG. 3 is a block diagram showing the internal structure of the digital camera 1. As shown in FIG. 3, the digital camera 1 comprises a photographing function portion 3 for processing image signals, an automatic focusing device 50 and a lens driver 18 for realizing automatic focusing control, and a camera controller 20 performing centralized control of the elements provided in the digital camera 1.

The subject image formed on the CCD image sensing device 30 through the taking lens 11 is converted into an electric signal comprising a plurality of pixels, that is, an image signal at the CCD image sensing device 30, and is directed to an A/D converter 31.

The A/D converter 31 converts the image signal output from the CCD image sensing device 30, for example, into a digital signal of 10 bits per pixel. The image signal output from the A/D converter 31 is directed to an image processor 33.

The image processor 33 performs image processings such as white balance adjustment, gamma correction and color correction on the image signal. At the time of live view image display, the image processor 33 supplies the image signal having undergone image processings to a live view image generator 35. At the time of automatic focusing control, the image processor 33 supplies the image signal to an image memory 36. At the time of photographing performed in response to a depression of the release button 8 (photographing for recording), the image processing 33 supplies the image signal having undergone image processings to an image compressor 34.

At the time of live view image display, the live view image generator 35 generates an image signal conforming to the liquid crystal display 16, and supplies the generated image signal to the liquid crystal display 16. Consequently, at the time of live view image display, image display is performed on the liquid crystal display 16 based on the image signals obtained by successively performing photoelectric conversion at the CCD image sensing device 30.

The image memory 36 is for temporarily storing an image signal to perform automatic focusing. In the image memory 36, an image signal is stored that is taken at each position of the taking lens 11 by control by the camera controller 20 while the position of the taking lens 11 is stepwisely shifted by the automatic focusing device 50.

The timing at which the image signal is stored from the image processor 33 into the image memory 36 is the timing at which automatic focusing control is performed. For this reason, to display an in-focus live view image on the liquid crystal display 16 at the time of live view image display, the image signal is stored into the image memory 36 also at the time of live view image display.

When the release button 8 is depressed, it is necessary to perform automatic focusing control before performing photographing for recording. Therefore, before photographing for recording is performed, the image signal taken at each lens position is stored into the image memory 36 while the position of the taking lens 11 is stepwisely driven. The automatic focusing device 50 obtains the image signal stored in the image memory 36 and performs the automatic focusing control according to the contrast method. After the automatic focusing control by the automatic focusing device 50 is performed and the taking lens 11 is driven to the in-focus position, photographing for recording is performed, and the image signal obtained by the photographing for recording is supplied to the image compressor 34.

The image compressor 34 compresses the image obtained by photographing for recording by a predetermined compression method. The compressed image signal is output from the image compressor 34 and recorded onto the recording medium 9.

The camera controller 20 is implemented by a CPU performing a predetermined program. When the user operates various kinds of operation buttons including the photographing mode setting buttons 14, the release button 8 and the operation buttons 17, the camera controller 20 controls the elements of the photographing function portion 3 and the automatic focusing device 50 according to the contents of the operation. Moreover, the camera controller 20 is linked to the automatic focusing device 50. At the time of automatic focusing control, when the automatic focusing device 50 stepwisely drives the position of the taking lens 11, the camera controller 20 controls the photographing operation of the CCD image sensing device 30 at each lens position, and stores the taken image signal into the image memory 36.

The lens driver 18 is driving means for moving the taking lens 11 along the optical axis in response to an instruction from the automatic focusing device 50, and changes the focus state of the subject image formed on the CCD image sensing device 30.

The automatic focusing device 50 comprising an image data obtainer 51, an area image extractor 52, an area identifier 53, an evaluation value calculator 54 and a driving controller 55 obtains the image signal stored in the image memory 36, and performs automatic focusing control according to the contrast method. That is, the automatic focusing device 50 operates so that the subject image formed on the CCD image sensing device 30 by the taking lens 11 is brought to the in-focus position.

The image data obtainer 51 obtains the image signal stored in the image memory 36. The area image extractor 52 extracts the image component (that is, the area image) included in the focus evaluation area from the obtained image signal.

The focus evaluation area is a unit area for calculating the evaluation value serving as the index value of the focus state in the contrast method, and a plurality of focus evaluation areas is set for the image stored in the image memory 36. By setting a plurality of focus evaluation areas, automatic focusing control can be performed in a wider range.

FIGS. 4 and 5 show an example of the focus evaluation areas. As shown in FIG. 4, a plurality of horizontal focus evaluation areas R1 to R15 is set for an image G10 stored in the image memory 36. The horizontal focus evaluation areas R1 to R15 serve as focus evaluation areas for calculating the evaluation value for focusing by extracting the contrast with respect to the horizontal direction (X direction) of the image G10.

Moreover, as shown in FIG. 5, a plurality of vertical focus evaluation areas R16 to R25 is also set for the image G10 stored in the image memory 36. The vertical focus evaluation areas R16 to R25 serve as focus evaluation areas for calculating the evaluation value for focusing by extracting the contrast with respect to the vertical direction (Y direction) of the image G 10.

That is, in this embodiment, all of the fifteen focus evaluation areas in the horizontal direction and the ten focus evaluation areas in the vertical direction serve as focus evaluation areas for evaluating the focus state.

Then, the area image extractor 52 extracts the image component (area image) included in each of the focus evaluation areas R1 to R25, and supplies the image component included in each of the focus evaluation areas R1 to R25 to the area identifier 53.

The area identifier 53 identifies an area used for automatic focusing control from ampng the focus evaluation areas R1 to R25. While in this embodiment, twenty-five focus evaluation areas for calculating the evaluation value representative of the focus state are set with respect to both the horizontal direction and the vertical direction of the image G10 as described above, performing the same evaluation value calculation for all of the evaluation areas decreases the efficiency in automatic focusing control. For this reason, based on the image characteristic of the image component of each of the focus evaluation areas, the area identifier 53 identifies, as a high-precision evaluation target area,-a focus evaluation area enabling automatic focusing control to be performed with high precision.

The evaluation value calculator 54 obtains the evaluation value of the identified focus evaluation area with high precision by increasing the number of evaluation target pixels of the high-precision evaluation target area identified by the area identifier 53 to a number larger than a predetermined number. Consequently, a highly precise automatic focusing control is performed at the automatic focusing device 50. For the other of the focus evaluation areas R1 to R25 that are not identified as the high-precision evaluation target area, the evaluation value calculator 54 obtains the evaluation value with the number of evaluation target pixels being set to the predetermined number or to a number smaller than the predetermined number, so that an efficient automatic focusing control is performed.

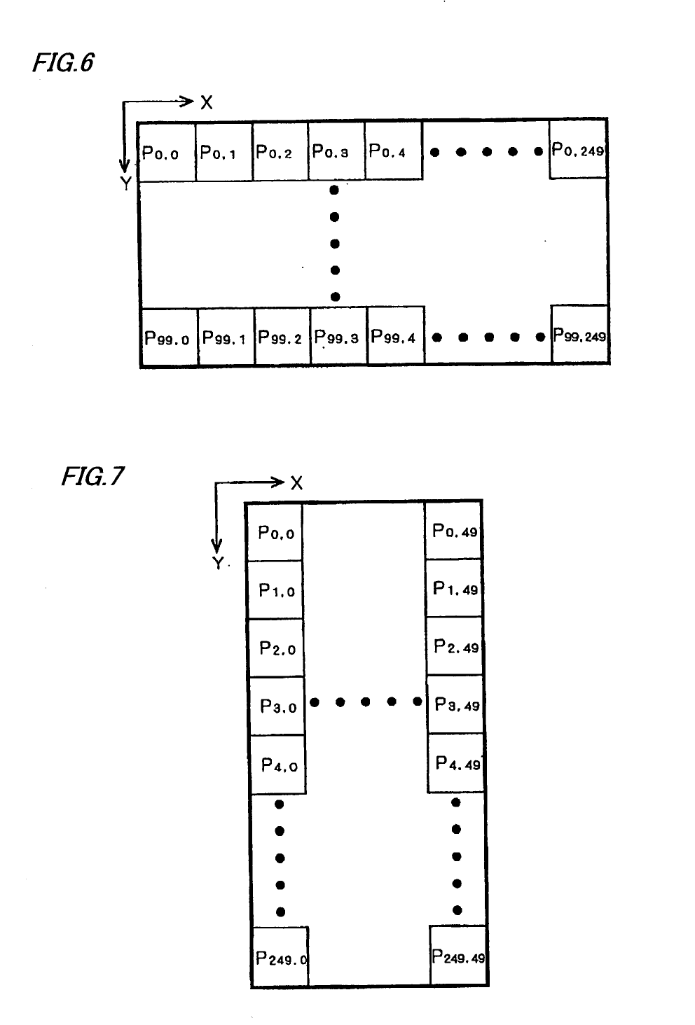

FIG. 6 is a view showing an example of the pixel arrangement in the horizontal focus evaluation areas R1 to R15. For example, when the size of the image G10 is 2000 pixels in the horizontal direction and 1500 pixels in the vertical direction, as shown in FIG. 6, the horizontal focus evaluation areas R1 to R15 are each a rectangular area in which 250 pixels are arranged in the horizontal direction (X direction) and 100 pixels are arranged in the vertical direction (Y direction). That is, by setting the direction of length of the rectangular area as the horizontal direction, the evaluation value based on the contrast in the horizontal direction can be excellently detected.

Generally, the evaluation value Ch of each of the horizontal focus evaluation areas R1 to R15 is obtained by the following expression 1:

$$Ch = {\sum }_{n = 0}^{9} {\sum }_{m = 0}^{245} {( {P}_{10 \cdot n , m} - {P}_{10 \cdot n , m + 4} )}^{2} \qquad [ Expression 1 ]$$

In the expression 1, n is the parameter for scanning the pixel position in the vertical direction (Y direction), m is the parameter for scanning the pixel position in the horizontal direction (X direction), and P is the pixel value (brightness value) of each pixel. To calculate the evaluation value Ch, by a calculation based on the expression 1, in each of the focus evaluation areas R1 to R15, the square value of the difference between the brightness values of a target pixel (P10·n,m) and a pixel (P10·n,m+4) four pixels ahead of the target pixel in the horizontal direction is obtained every ten horizontal lines, and the sum total of the square values of the differences in each focus evaluation area is obtained. The sum total is the evaluation value Ch.

When the area identifier 53 identifies some of the horizontal focus evaluation areas R1 to R15 as high-precision evaluation target areas, for the high-precision evaluation target areas, the calculation of the square value of the difference is not performed every ten horizontal lines but the calculation of the square value of the difference is performed, for example, every five horizontal lines so that the number of evaluation target pixels in each area is increased. Consequently, for the high-precision evaluation target areas, the number of pixels (the number of samples) evaluated in the calculation of the evaluation value is increased, so that the evaluation value can be obtained with high precision.

On the contrary, for the other horizontal focus evaluation areas that are not identified as the high-precision evaluation target areas, the calculation of the square value of the difference is performed every ten horizontal lines, the default value, or the calculation of the square value of the difference is performed, for example, every twenty horizontal lines so that the number of evaluation target pixels in each area is decreased. Consequently, for the areas other than the high-precision evaluation target areas, the calculation of the evaluation value can be efficiently performed, so that an efficient automatic focusing control can be performed.

That is, in this embodiment, the evaluation value Ch in each of the horizontal focus evaluation areas R1 to R15 is obtained based on the expression 2 obtained by converting the arithmetic expression to extract an evaluation target pixel every ten horizontal lines in the expression 1 shown above, into an arithmetic expression to extract an evaluation target pixel every k1 horizontal lines (here, k1 is an arbitrary positive number).

$$Ch = {\sum }_{n = 0}^{N} {\sum }_{m = 0}^{245} {( {P}_{k1 n , m} - {P}_{k1 \cdot n , m + 4} )}^{2} \qquad [ Expression 2 ]$$

In the expression 2, N is an integer obtained by N=100/k1−1.

The parameter k1 in the expression 2 is set by the area identifier 53 to a value higher than a predetermined value or a value lower than the predetermined value according to the image characteristics of the horizontal focus evaluation areas R1 to R15. For the horizontal focus evaluation areas identified as the high-precision evaluation target areas, the parameter k1 is set, for example, to 5. For the other horizontal focus evaluation areas not identified as the high-precision evaluation target areas, the parameter k1 is set, for example, to 10 or 20. By the evaluation value calculator 54 performing the calculation based on the expression 2, for the high-precision evaluation target areas, a highly precise evaluation value calculation can be performed by increasing the number of evaluation target pixels, and for the other areas, the calculation time can be reduced, so that the calculation of the evaluation value can be efficiently performed.

FIG. 7 is a view showing an example of the pixel arrangement in the vertical focus evaluation areas R16 to R25. For example, when the size of the image G10 is 2000 pixels in the horizontal direction and 1500 pixels in the vertical direction, as shown in FIG. 7, the vertical focus evaluation areas R16 to R25 are each a rectangular area in which 50 pixels are arranged in the horizontal direction (X direction) and 250 pixels are arranged in the vertical direction (Y direction). That is, by setting the direction of length of the rectangular area as the vertical direction, the evaluation value based on the contrast in the vertical direction can be excellently detected.

Generally, the evaluation value Cv of each of the vertical focus evaluation areas R16 to R25 is obtained by the following expression 3:

$$Cv = {\sum }_{n = 0}^{9} {\sum }_{m = 0}^{245} {( {P}_{n , 5 \cdot m} - {P}_{n + 4 , 5 \cdot m} )}^{2} \qquad [ Expression 3 ]$$

In the expression 3, n is the parameter for scanning the pixel position in the vertical direction (Y direction), m is the parameter for scanning the pixel position in the horizontal direction (X direction), and P is the pixel value (brightness value) of each pixel. To calculate the evaluation value Cv, by a calculation based on the expression 3, in each of the focus evaluation areas R16 to R25, the square value of the difference between the brightness values of a target pixel (Pn,5·m) and a pixel (Pn+4,5·m) four pixels ahead of the target pixel in the vertical direction is obtained every five vertical lines, and the sum total of the square values of the differences in each focus evaluation area is obtained. The sum total is the evaluation value Cv.

When the area identifier 53 identifies some of the vertical focus evaluation areas R16 to R25 as high-precision evaluation target areas, for the high-precision evaluation target areas, the calculation of the square value of the difference is not performed every five vertical lines but the calculation of the square value of the difference is performed, for example, every two vertical lines so that the number of evaluation target pixels in each area is increased. Consequently, for the high-precision evaluation target areas, the number of pixels (the number of samples) evaluated in the calculation of the evaluation value is increased, so that the evaluation value can be obtained with high precision.

On the contrary, for the other vertical focus evaluation areas that are not identified as the high-precision evaluation target areas, the calculation of the square value of the difference is performed every five vertical lines, the default value, or the calculation of the square value of the difference is performed, for example, every ten vertical lines so that the number of evaluation target pixels in each area is decreased. Consequently, for the areas other than the high-precision evaluation target areas, the calculation of the evaluation value can be efficiently performed, so that an efficient automatic focusing control can be performed.

That is, in this embodiment, the evaluation value Cv in each of the focus evaluation areas R16 to R25 is obtained based on the expression 4 obtained by converting the arithmetic expression to extract an evaluation target pixel every five vertical lines in the expression 3 shown above, into an arithmetic expression to extract an evaluation target pixel every k2 vertical lines (here, k2 is an arbitrary positive number).

$$Cv = {\sum }_{n = 0}^{M} {\sum }_{m = 0}^{245} {( {P}_{n , k2 \cdot m} - {P}_{n + 4 , k2 \cdot m} )}^{2} \qquad [ Expression 4 ]$$

In the expression 4, M is an integer obtained by M=50/k2−1.

The parameter k2 in the expression 4 is set by the area identifier 53 to a value higher than a predetermined value or a value lower than the predetermined value according to the image characteristics of the vertical focus evaluation areas R16 to R25. For the vertical focus evaluation areas identified as the high-precision evaluation target areas, the parameter k2 is set, for example, to 2, for the other vertical focus evaluation areas not identified as the high-precision evaluation target areas, the parameter k2 is set, for example, to 5 (or 10), and the evaluation value calculator 54 performs the calculation based on the expression 4 to calculate the evaluation value Cv. By performing the calculation as described above, for the high-precision evaluation target areas, a highly precise evaluation value calculation can be performed by increasing the number of evaluation target pixels, and for the other areas, the calculation time can be reduced, so that the calculation of the evaluation value can be efficiently performed.

It is desirable that the expression 1 or the expression 3 be set as the default setting in performing the calculation of the evaluation value and the area identifier 53 obtain the value of the parameter k1 or k2 shown in the expression 2 or 4 based on the image characteristics of the image components of the focus evaluation areas R1 to R25.

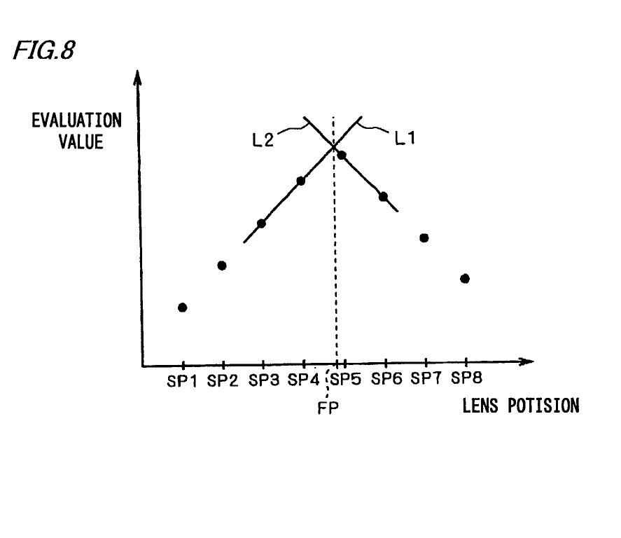

With attention given to one focus evaluation area, the position of the taking lens 11 is stepwisely shifted and the evaluation value Ch (or Cv) is obtained based on the image signal obtained at each lens position. Then, the relationship between the lens position and the evaluation value Ch (or Cv) varies as shown in FIG. 8.

FIG. 8 is a view showing a variation of the evaluation value (evaluation value characteristic curve) when the taking lens 11 is driven. When the evaluation value Ch or Cv is obtained at each of the lens positions SP1, SP2, . . . while the taking lens 11 is stepwisely driven at regular intervals, the evaluation value gradually increases to a certain lens position, and thereafter, the evaluation value gradually decreases. The peak position (the highest point) of the evaluation value is the in-focus position FP of the taking lens 11. In the example of FIG. 8, the in-focus position FP is present between the lens positions SP4 and SP5.

The evaluation value calculator 54 obtains the evaluation value Ch (or Cv) at each lens position, and performs a predetermined interpolation processing on the evaluation value at each lens position to obtain the in-focus position FP. As an example of the interpolation processing, the lens positions SP3 and SP4 before the peak is reached and the lens positions SP5 and SP6 after the peak is reached are identified, and a straight line L1 passing through the evaluation values at the lens positions SP3 and SP4 and a straight line L2 passing through the evaluation values at the lens positions SP5 and SP6 are set. Then, the point of intersection of the straight lines L1 and L2 is identified as the peak point of the evaluation value, and the lens position corresponding thereto is identified as the in-focus position FP.

When this processing is performed for each of the focus evaluation areas R1 to R25, there is a possibility that different in-focus positions FP are identified among the focus evaluation areas R1 to R25. Therefore, the evaluation value calculator 54 finally identifies one in-focus position. For example, the evaluation value calculator 54 selects, from among the in-focus positions FP obtained from the evaluation target areas R1 to R25, the in-focus position where the subject is determined to be closest to the digital camera 1 (that is, the nearest side position), and identifies the position as the final in-focus position.

Then, in-focus state of the digital camera 1 is realized by the driving controller 55 controlling the lens driver 18 so that the taking lens is moved to the in-focus position finally identified by the evaluation value calculator 54.

In the digital camera 1 and the automatic focusing device 50 of this embodiment, the image component is extracted from each of a plurality of focus evaluation areas set in an image, high-precision evaluation target areas in detecting the in-focus position of the taking lens 11 are identified from among the plural focus evaluation areas based on the image characteristics of the image components obtained from the plural focus evaluation areas, and for the identified high-precision evaluation target areas, the evaluation value associated with the focus state of the taking lens 11 is obtained by use of a larger number of pixels than for the other focus evaluation areas. Consequently, automatic focusing control can be performed highly precisely and efficiently. When the image characteristic of each focus evaluation area is evaluated, it is desirable to evaluate the contrast, the hue or the like of the image component, and this will be described later.

While an example has been described in which a plurality of focus evaluation areas R1 to R25 are divided into high-precision evaluation target areas and the other areas, a structure may be employed such that the plural focus evaluation areas identified as the high-precision evaluation target areas are set as an evaluation target area group, the plural focus evaluation areas not identified as the high-precision evaluation target areas are set as a non-evaluation area group, and the calculation of the evaluation value is not performed for the non-evaluation area group. Since this structure makes it unnecessary to perform the calculation of the evaluation value for the non-evaluation area group, a more efficient automatic focusing control can be performed.

Moreover, a structure may be employed such that by evaluating the image components of the focus evaluation areas R1 to R25, first, the division into the evaluation target area group and the non-evaluation area group is made and high-precision evaluation target areas are identified from the evaluation target area group. By first dividing the focus evaluation areas R1 to R25 into the evaluation target area group and the non-evaluation area group, it is unnecessary to perform the calculation of the evaluation value for the non-evaluation area group also in this case, so that automatic focusing control can be more efficiently performed.

<2. Operation of the digital camera 1>

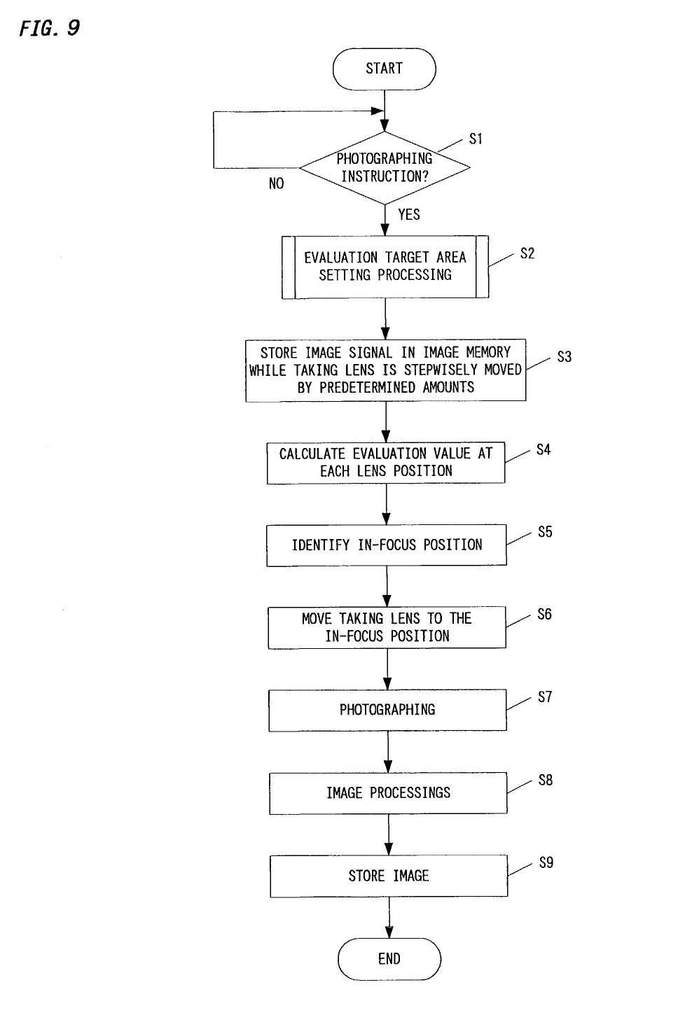

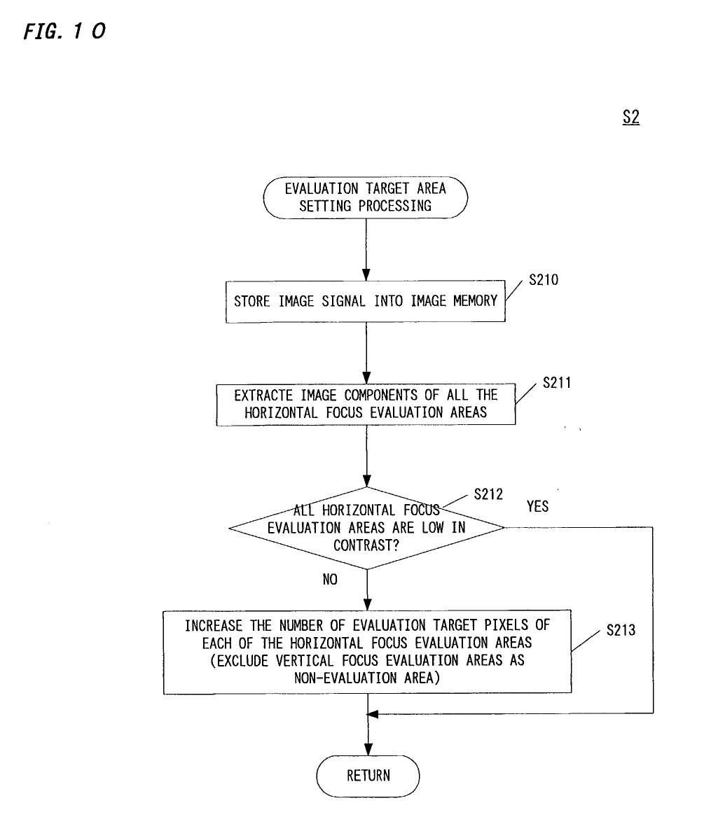

Next, the operation of the digital camera 1 will be described. FIGS. 9 to 13 are flowcharts showing the focusing operation of the digital camera 1, and show as an example a case where automatic focusing control is performed when the user depresses the release button 8. FIG. 9 shows the overall operation of the digital camera 1. FIGS. 10 to 13 each show a different processing for the parameter setting processing (evaluation target area setting processing) when the calculation of the evaluation value is performed for the plural focus evaluation areas R1 to R25.

First, the overall operation will be described. As shown in FIG. 9, the camera controller 20 of the digital camera 1 determines whether or not the user inputs a photographing instruction by depressing the release button 8 (step S1). When the user inputs a photographing instruction, automatic focusing control for bringing the subject image formed on the CCD image sensing device 30 in the digital camera 1 to in-focus state is started.

When automatic focusing control is started, first, the evaluation target area setting processing is performed (step S2). The evaluation target area setting processing is a processing to identify high-precision evaluation target areas from among a plurality of focus evaluation areas or select the evaluation target area group and identify high-precision evaluation target areas from the evaluation target area group. When the evaluation target area group is selected from among a plurality of focus evaluation areas, for the focus evaluation areas not selected as the evaluation target area group, the calculation of the evaluation value is not performed because they are set as the non-evaluation area group (that is, area group not being a target of evaluation), thereby increasing the efficiency of the calculation processing. The evaluation target area setting processing is also a processing to set the parameter k1 or k2 for each line when the calculation based on the expression 2 or 4 is performed for each focus evaluation area.

The parameter k1 or k2 set at this time is temporarily stored in a non-illustrated memory provided in the automatic focusing device 50. Then, when the calculation processing based on the expression 2 or 4 is performed for the image signals successively obtained while the taking lens 11 is stepwisely moved, a calculation to obtain the evaluation value Ch or Cv is performed by applying the parameter k1 or k2 obtained for each focus evaluation area to the expression 2 or 4.

When the evaluation target area setting processing (step S2) is finished, the image signal obtained at each lens position is stored in the image memory 36 while the taking lens 11 is stepwisely moved by predetermined amounts (step S3).

Then, the processing to calculate the evaluation value at each lens position (step S4) is performed. At this time, a calculation based on the expression 2 or 4 is performed by use of the parameter k1 or k2 set for each focus evaluation area in the evaluation target area setting processing, thereby obtaining the evaluation value Ch or Cv for each focus evaluation area. Then, the calculation processing is performed for each of the image signals obtained when the taking lens 11 is stepwisely moved, so that the evaluation value characteristic curve as shown in FIG. 8 is obtained for each focus evaluation area. At this time, for the high-precision evaluation target areas, since the calculation of the evaluation value is performed with a large number of evaluation target pixels being set, a highly precise evaluation value can be obtained, and for the focus evaluation areas other than the high-precision evaluation target areas, the calculation processing can be promptly completed.

Then, the in-focus position FP where the evaluation value Ch or Cv is highest is obtained for each focus evaluation area, and a single in-focus position is identified from among the in-focus positions FP obtained for the focus evaluation areas (step S5).

Then, the driving controller 55 outputs a driving signal to the lens driver 18 to move the taking lens 11 to the in-focus position obtained at step S5 (step S6). Consequently, the subject image formed on the CCD image sensing device 30 through the taking lens 11 is in focus.

Then, the processing of the photographing for recording is performed (step S7), predetermined image processings are performed on the image signal representative of the in-focus photographed subject image (step S8), and the image is stored into the recording medium 9 (step S9).

By performing the automatic focusing control as described above, compared to a case where a plurality of focus evaluation areas is set and the same processing is performed for all the areas, for the high-precision evaluation target areas, the evaluation value can be obtained with high precision, and for the other areas, an efficient calculation processing can be performed, so that a highly precise and prompt automatic focusing control can be performed.

Next, referring to FIG. 10, a first processing mode of the evaluation target area setting processing (step S2) will be described. First, before the automatic focusing device 50 stepwisely moves the taking lens 11, the image signal obtained by the CCD image sensing device 30 is stored into the image memory 36 (step S210).

When the automatic focusing device 50 functions, the image signal is obtained from the image memory 36, and the image components of all the horizontal focus evaluation areas R1 to R15 are extracted (step S211). Then, the area identifier 53 performs a comparatively simple calculation to obtain the contrast for all the horizontal focus evaluation areas R1 to R15, and evaluates the contrast of each of the horizontal focus evaluation areas R1 to R15 (step S212). That is, by comparing the contrast obtained for each of the horizontal focus evaluation areas R1 to R15 with a predetermined value, the contrast is evaluated as the image characteristic of the image component, and it is determined whether all the horizontal focus evaluation areas R1 to R15 are low in contrast or not.

When at least one of the horizontal focus evaluation areas R1 to R15 is not low in contrast, the process proceeds to step S213, where the area identifier 53 identifies all the horizontal focus evaluation areas R1 to R15 as the high-precision evaluation target areas and increases the number of evaluation target pixels of each of the horizontal focus evaluation areas R1 to R15. At this time, the vertical focus evaluation areas R16 to R25 are excluded from the target of the calculation of the evaluation value as the non-evaluation area group. Consequently, for the horizontal focus evaluation areas R1 to R15, the evaluation value can be obtained with high precision, and for the vertical focus evaluation areas R16 to R25, since the calculation of the evaluation value is not performed, the time required for the calculation of the evaluation value can be reduced.

When all the horizontal focus evaluation areas R1 to R15 are low in contrast, no high-precision evaluation target area is identified, and the process exits from the evaluation target area setting processing (step S2) and the calculation of the evaluation value is performed with the parameter k1 or k2 being the default setting.

By performing the evaluation target area setting processing (step S2) based on the first processing mode shown in FIG. 10 as described above, when the image characteristics of the horizontal focus evaluation areas R1 to R15 of the focus evaluation areas R1 to R25 are not low contrast, a highly precise and efficient automatic focusing control is realized.

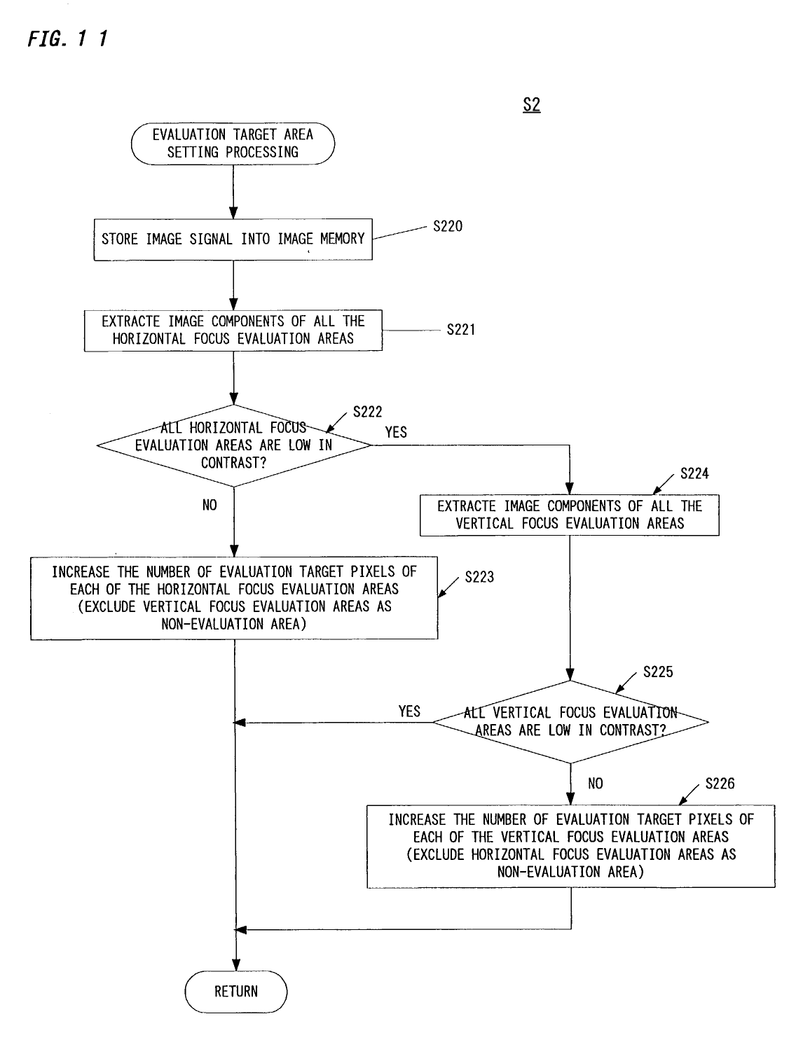

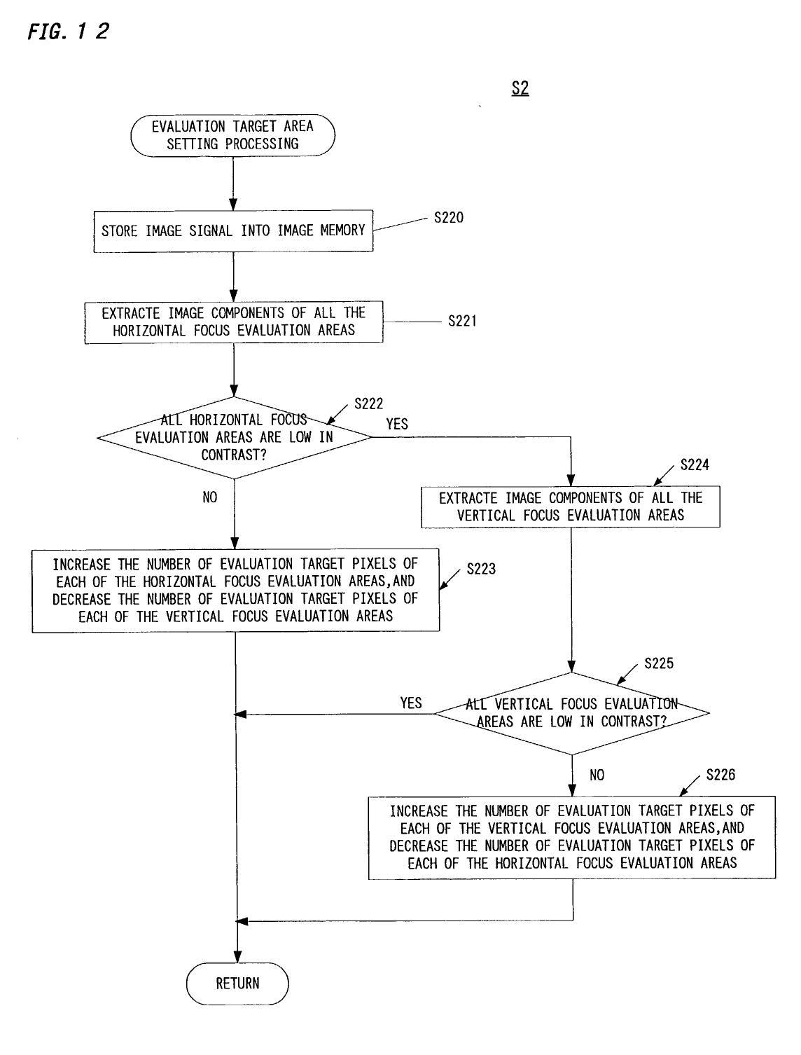

Next, referring to FIG. 11, a second processing mode of the evaluation target area setting processing (step S2) will be described. First, before the automatic focusing device 50 stepwisely moves the taking lens 11, the image signal obtained by the CCD image sensing device 30 is stored into the image memory 36 (step S220).

When the automatic focusing device 50 functions, the image signal is obtained from the image memory 36, and the image components of all the horizontal focus evaluation areas R1 to R15 are extracted (step S221). Then, the area identifier 53 performs a comparatively simple calculation to obtain the contrast for all the horizontal focus evaluation areas R1 to R15, and evaluates the contrast of each of the horizontal focus evaluation areas R1 to R15 (step S222). That is, by comparing the contrast obtained for each of the horizontal focus evaluation areas R1 to R15 with a predetermined value, it is determined whether all the horizontal focus evaluation areas R1 to R15 are low in contrast or not.

When at least one of the horizontal focus evaluation areas R1 to R15 is not low in contrast, the process proceeds to step S223, where the area identifier 53 identifies all the horizontal focus evaluation areas R1 to R15 as the high-precision evaluation target areas and increases the number of evaluation target pixels of each of the horizontal focus evaluation areas R1 to R15. At this time, the vertical focus evaluation areas R16 to R25 are excluded from the target of the calculation of the evaluation value as the non-evaluation area group. Consequently, for the horizontal focus evaluation areas R1 to R15, the evaluation value can be obtained with high precision, and for the vertical focus evaluation areas R16 to R25, since the calculation of the evaluation value is not performed, the time required for the calculation of the evaluation value can be reduced.

When all the horizontal focus evaluation areas R1 to R15 are low in contrast, the process proceeds to step S224 to extract the image components of all the vertical focus evaluation areas R16 to R25 (step S224). Then, the area identifier 53 performs a comparatively simple calculation to obtain the contrast for all the vertical focus evaluation areas R16 to R25, and evaluates the contrast of each of the vertical focus evaluation areas R16 to R25 (step S225). That is, by comparing the contrast obtained for each of the vertical focus evaluation areas R16 to R25 with a predetermined value, it is determined whether all the vertical focus evaluation areas R16 to R25 are low in contrast or not.

When at least one of the vertical focus evaluation areas R16 to R25 is not low in contrast, the process proceeds to step S226, where the area identifier 53 identifies all the vertical focus evaluation areas R16 to R25 as the high-precision evaluation target areas and increases the number of evaluation target pixels of each of the vertical focus evaluation areas R16 to R25. At this time, the horizontal focus evaluation areas R1 to R15 are excluded from the target of the calculation of the evaluation value as the non-evaluation area group. Consequently, for the vertical focus evaluation areas R16 to R25, the evaluation value can be obtained with high precision, and for the horizontal focus evaluation areas R1 to R15, since the calculation of the evaluation value is not performed, the time required for the calculation of the evaluation value can be reduced.

When all the vertical focus evaluation areas R16 to R25 are also low in contrast (YES of step S225), no high-precision evaluation target area is identified, and the process exits from the evaluation target area setting processing (step S2) and the calculation of the evaluation value is performed with the parameter k1 or k2 being the default setting.

By performing the evaluation target area setting processing (step S2) based on the second processing mode shown in FIG. 11 as described above, when an area not low in contrast is present among the horizontal focus evaluation areas R1 to R15 and the vertical focus evaluation areas R16 to R25, either of the horizontal focus evaluation areas R1 to R15 and the vertical focus evaluation areas R16 to R25 is identified as the high-precision evaluation target areas and the other is set as the non-evaluation area group, so that a highly precise and efficient automatic focusing control is realized.

While at step S223 of the present embodiment, the area identifier 53 identifies all the horizontal focus evaluation areas R1 to R15 as the high-precision evaluation target areas and increases the number of evaluation target pixels, the present invention is not limited thereto. The area identifier 53 may increase the numbers of evaluation target pixels of only the areas of the horizontal focus evaluation areas R1 to R15 that are not low in contrast and decrease the numbers of evaluation target pixels of the low-contrast areas from the default value. This increases the numbers of evaluation target pixels of only the areas of the horizontal focus evaluation areas that are considered to be associated with focusing, so that a more highly precise and efficient automatic focusing control can be performed.

Step 226 associated with the vertical focus evaluation areas R16 to R25 is similar to the above, and the area identifier 53 may increase the numbers of evaluation target pixels of only the areas of the vertical focus evaluation areas R16 to R25 that are not low in contrast and decrease the numbers of evaluation target pixels of the low-contrast areas from the default value.

Next, referring to FIG. 12, a third processing mode of the evaluation target area setting processing (step S2) will be described. First, before the automatic focusing device 50 stepwisely moves the taking lens 11, the image signal obtained by the CCD image sensing device 30 is stored into the image memory 36 (step S230).

When the automatic focusing device 50 functions, the image signal is obtained from the image memory 36, and the image components of all the horizontal focus evaluation areas R1 to R15 are extracted (step S231). Then, the area identifier 53 performs a comparatively simple calculation to obtain the contrast for all the horizontal focus evaluation areas R1 to R15, and evaluates the contrast of each of the horizontal focus evaluation areas R1 to R15 (step S232). That is, by comparing the contrast obtained for each of the horizontal focus evaluation areas R1 to R15 with a predetermined value, it is determined whether all the horizontal focus evaluation areas R1 to R15 are low in contrast or not.

When at least one of the horizontal focus evaluation areas R1 to R15 is not low in contrast, the process proceeds to step S233, where the area identifier 53 identifies all the horizontal focus evaluation areas R1 to R15 as the high-precision evaluation target areas and increases the number of evaluation target pixels of each of the horizontal focus evaluation areas R1 to R15. At this time, the numbers of evaluation target pixels of the vertical focus evaluation areas R16 to R25 are decreased from the default value. Consequently, for the horizontal focus evaluation areas R1 to R15, the evaluation value can be obtained with high precision, and for the vertical focus evaluation areas R16 to R25, the calculation of the evaluation value can be efficiently performed.

When all the horizontal focus evaluation areas R1 to R15 are low in contrast, the process proceeds to step S234, and the image components of all the vertical focus evaluation areas R16 to R25 are extracted (step S234). Then, the area identifier 53 performs a comparatively simple calculation to obtain the contrast for all the vertical focus evaluation areas R16 to R25, and evaluates the contrast of each of the vertical focus evaluation areas R16 to R25 (step S235). That is, by comparing the contrast obtained for each of the vertical focus evaluation areas R16 to R25 with a predetermined value, it is determined whether all the vertical focus evaluation areas R16 to R25 are low in contrast or not.

When at least one of the vertical focus evaluation areas R16 to R25 is not low in contrast, the process proceeds to step S236, where the area identifier 53 identifies all the vertical focus evaluation areas R16 to R25 as the high-precision evaluation target areas and increases the number of evaluation target pixels of each of the vertical focus evaluation areas R16 to R25. At this time, the numbers of evaluation target pixels of the horizontal focus evaluation areas R1 to R15 are decreased from the default value. Consequently, for the vertical focus evaluation areas R16 to R25, the evaluation value can be obtained with high precision, and for the horizontal focus evaluation areas R1 to R15, the calculation of the evaluation value can be efficiently performed.

When all the vertical focus evaluation areas R16 to R25 are also low in contrast (YES of step S235), no high-precision evaluation target area is identified, and the process exits from the evaluation target area setting processing (step S2) and the calculation of the evaluation value is performed with the parameter k1 or k2 being the default setting.

By performing the evaluation target area setting processing (step S2) based on the third processing mode shown in FIG. 12 as described above, when an area not low in contrast is present among the horizontal focus evaluation areas R1 to R15 and the vertical focus evaluation areas R16 to R25, either of the horizontal focus evaluation areas R1 to R15 and the vertical focus evaluation areas R16 to R25 is identified as the high-precision evaluation target areas and the high-precision evaluation value calculation is performed therefor, whereas for the other, the calculation of the evaluation value is performed with a decreased number of evaluation target pixels. Consequently, a highly precise and efficient automatic focusing control is realized.

Any of the above-described first to third processing modes may be adopted. Moreover, the high-precision evaluation target areas may be obtained by evaluating the distribution condition of the color components of the image component of each focus evaluation area as described next.

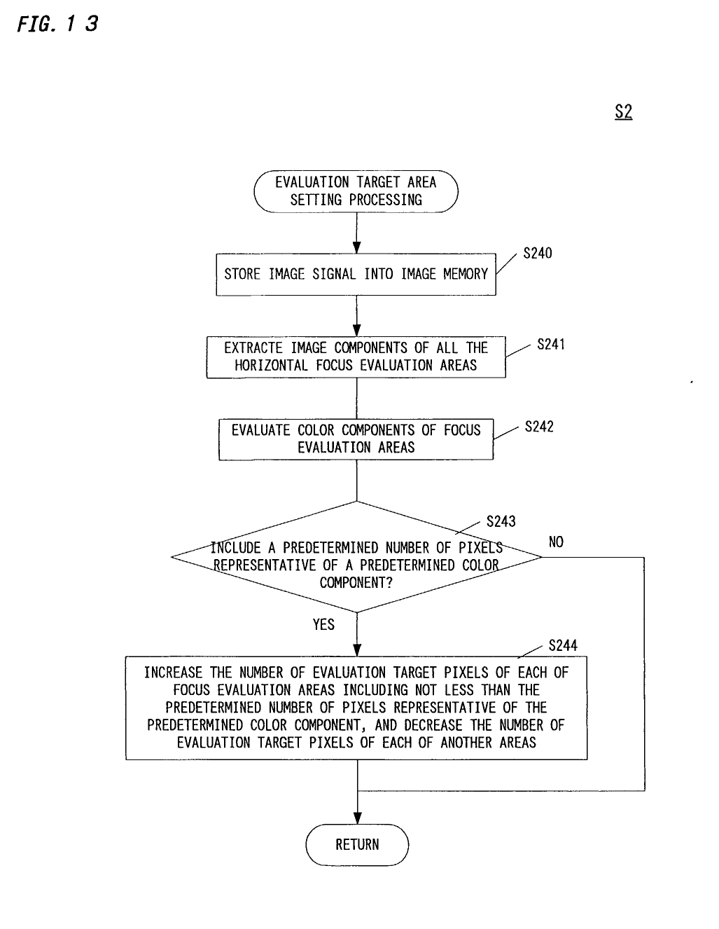

Referring to FIG. 13, a fourth processing mode of the evaluation target area setting processing (step S2) will be described. First, before the automatic focusing device 50 stepwisely moves the taking lens 11, the image signal obtained by the CCD image sensing device 30 is stored into the image memory 36 (step S240).

When the automatic focusing device 50 functions, the image signal is obtained from the image memory 36, and the image components of all the focus evaluation areas R1 to R25 are extracted (step S241). Then, the area identifier 53 evaluates the distribution condition of the color components of the focus evaluation areas R1 to R25 (step S242). Specifically, the image signal comprising color components of R (red), G (green) and B (blue) stored in the image memory 36 is converted into calorimetric system data expressed by Yu‘v’, and the number of pixels included in a predetermined color area on the u‘v’ coordinate space is counted for each focus evaluation area. Then, it is determined whether not less than a predetermined number of pixels representative of a predetermined color component are present in each of the focus evaluation areas R1 to R15 or not (step S243).

For example, when the photographing mode is the portrait mode, the predetermined color component is set to the skin color component. This enables a highly precise automatic focusing control to be performed for a person subject. When the photographing mode is the landscape mode, the predetermined color component is set to a green component or the like, and this enables a highly precise automatic focusing control to be performed for a landscape subject.

When not less than the predetermined number of pixels representative of the predetermined color component are present in any of the focus evaluation areas R1 to R25, the process proceeds to step S244, where the area identifier 53 identifies, of the focus evaluation areas R1 to R25, the focus evaluation areas including not less than the predetermined number of pixels representative of the predetermined color component as the high-precision evaluation target areas, and the numbers of evaluation target pixels of the identified areas are increased. On the contrary, the numbers of evaluation target pixels of the focus evaluation areas not including not less than the predetermined number of pixels representative of the predetermined color component are decreased. Consequently, for the focus evaluation areas including a large number of pixels representative of the predetermined color component, the evaluation value can be obtained with high precision, and for the focus evaluation areas including a small number of pixels representative of the predetermined color component, the calculation of the evaluation value can be efficiently performed.

When none of the focus evaluation areas R1 to R25 has not less than the predetermined number of pixels representative of the predetermined color component, no high-precision evaluation target area is identified, and the process exits from the evaluation target area setting processing (step S2) and the calculation of the evaluation value is performed with the parameter k1 or k2 being the default setting.

By performing the evaluation target area setting processing (step S2) based on the fourth processing mode shown in FIG. 13 as described above, a high-precision evaluation value calculation can be performed for, of the focus evaluation areas R1 to R25, the focus evaluation areas having a large number of pixels representative of the predetermined color component, and the calculation of the evaluation value can be efficiently performed for the focus evaluation areas having a small number of pixels representative of the predetermined color component. Therefore, for example, by setting the skin color component, the green component or the like as the predetermined color component according to the photographing mode as described above, an automatic focusing control suitable for the subject is appropriately realized according to the photographing mode, and a highly precise and efficient control operation can be performed.

While a case where automatic focusing control is performed when the user depresses the release button 8 is described in the above, the time when automatic focusing control is performed is not limited to when the release button 8 is depressed.

<3. Modification>

While an embodiment of the present invention has been described, the present invention is not limited to the contents described above.

For example, since the function of the automatic focusing device 50 can be also implemented by a CPU performing predetermined software, it is not always necessary that the elements of the automatic focusing device 50 be structured so as to be distinguished from each other.

While automatic focusing control of the digital camera 1 is described in the description given above, the above-described automatic focusing technology is applicable not only to the digital camera 1 but also to film-based cameras.

While a case where the difference calculation is performed between a target pixel and a pixel four pixels ahead of the target pixel in performing the calculation of the evaluation value is shown as an example in the description given above, the present invention is not limited thereto. It is necessary only that the difference calculation is performed between two pixels in a predetermined positional relationship.

As described above, according to the present invention, an area image is extracted from each of a plurality of areas set in an image, high-precision evaluation target areas in detecting the in-focus position of the taking lens are identified from among the plural areas based on the image characteristics of the area images, and for the high-precision evaluation target areas, the evaluation value associated with the focus state of the taking lens is obtained by use of a larger number of pixels than for the other areas. Consequently, for the high-precision evaluation target areas, the evaluation value can be obtained with high precision, and for the other areas, the evaluation value can be efficiently obtained, so that a highly precise and prompt automatic focusing control can be performed.

Moreover, according to the present invention, an area group selection is made to select, from a first area group and a second area group each comprising a plurality of areas within the photographing image plane, the first or the second area group based on the image characteristics, for the selected area group, the evaluation value associated with the focus state of the taking lens is obtained by use of a larger number of pixels than for the other area group, and the taking lens is driven to the in-focus position based on the evaluation value, so that for the high-precision evaluation target areas, the evaluation value can be obtained with high precision and for the other areas, the evaluation value can be efficiently obtained. Consequently, a highly precise and prompt automatic focusing control can be performed.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. An automatic focusing apparatus receiving an image that comprises a plurality of pixels and controlling focusing of a taking lens, comprising:
an area image extractor for extracting an area image from each of a plurality of areas set in the image;
an area identifier for identifying, from among the plural areas, a high-precision evaluation target area based on an image characteristic of each of the image areas obtained from the plural areas;
an evaluation value calculator for obtaining, for the high-precision evaluation target area among the plural areas, an evaluation value associated with focus state of the taking lens by use of a larger number of pixels than for the other areas; and
a controller for driving the taking lens to an in-focus position based on the evaluation value.

2. The automatic focusing apparatus according to claim 1, wherein the evaluation value calculator obtains the evaluation value associated with the focus state of the taking lens by more than a predetermined number of pixels for the high-precision evaluation target area, and obtains the evaluation value associated with the focus state of the taking lens by use of less than the predetermined number of pixels for the other areas.

3. The automatic focusing apparatus according to claim 1, wherein the area identifier obtains, as the image characteristic, a contrast of each of the area images obtained from the plural areas, and when the contrast is higher than a predetermined value, the high-precision evaluation target area is identified from among the plural areas.

4. The automatic focusing apparatus according to claim 1, wherein the area identifier obtains, as the image characteristic, a distribution of color components of pixels of each of the area images obtained from the plural areas, and when the number of pixels representative of a predetermined color component is larger than a predetermined number, identifies the high-precision evaluation target area from among the plural areas.

5. The automatic focusing apparatus according to claim 4, wherein the predetermined color component is a skin color component.

6. The automatic focusing apparatus according to claim 1, wherein the area identifier selects an evaluation target area group from among the plural areas based on the image characteristic, and identifies the high-precision evaluation target area from the evaluation target area group.

7. The automatic focusing apparatus according to claim 6, wherein the evaluation value calculator obtains the evaluation value associated with the focus state of the taking lens by use of less than the predetermined number of pixels for, of the plural areas, areas included in the evaluation target area group and not included in the high-precision evaluation target area.

8. The automatic focusing apparatus according to claim 6, wherein the plural areas comprise a plurality of horizontal areas and a plurality of vertical areas, and the area identifier selects either of the plural horizontal areas and the plural vertical areas as the evaluation target area group.

9. An automatic focusing method for inputting an image that comprises a plurality of pixels and controlling focusing of a taking lens, comprising:
(a) a step of extracting an area image from each of a plurality of areas set in the image;
(b) a step of identifying, from among the plural areas, a high-precision evaluation target area based on an image characteristic of each of the image areas obtained from the plural areas;
(c) a step of obtaining, for the high-precision evaluation target area of the plural areas, an evaluation value associated with focus state of the taking lens by use of a larger number of pixels than for the other areas; and
(d) a step of driving the taking lens to an in-focus position based on the evaluation value.

10. An automatic focusing apparatus comprising:
a first setting part for setting a first area group comprising a plurality of areas within a photographing image plane;
a second setting part for setting a second area group comprising a plurality of areas within the photographing image plane;
an area group selecting part for selecting the first or the second area group based on an image characteristic;
an evaluation value calculating part for obtaining, for the selected area, an evaluation value associated with focus state of a taking lens by use of a larger number of pixels than for the other areas;
a driving controlling part for driving the taking lens to an in-focus position based on the evaluation value.

11. The automatic focusing apparatus according to claim 10, wherein the area groups are set based on a direction of arrangement of longer sides of each area within the photographing image plane.

12. The automatic focusing apparatus according to claim 11, wherein the direction of arrangement of the longer sides of the areas of the first area group and the direction of arrangement of the longer sides of the areas of the second area group are vertical to each other.

13. The automatic focusing apparatus according to claim 10, further comprising:
an area identifying part for identifying a high-precision evaluation target area based on the image characteristic in the selected area group.

14. The automatic focusing apparatus according to claim 11, wherein the evaluation value calculating part obtains, for an area included in the selected area group and not included in the high-precision evaluation target area, the evaluation value associated with the focus state of the taking lens by use of pixels of a number smaller than for the high-precision evaluation target area and larger than for each area of a non-selected area group.

15. The automatic focusing apparatus according to claim 11, wherein the area group selecting part uses a contrast of each of the area images obtained from the plural area as the image characteristic.
